(19) United States
(12) Patent Application Publication
(10) Pub. No.: US 2019/0078992 A1
(43) Pub. Date: Mar. 14, 2019

(54) Rapid Bubble Point Filter Tester

(71) Applicant: BOARD OF REGENTS, THE UNIVERSITY OF TEXAS SYSTEM, Austin, TX (US)

(72) Inventors: Richard S. Martin, Lancaster, TX (US); Jeff D. Liticker, Mesquite, TX (US)

(21) Appl. No.: 16/124,415

(22) Filed: Sep. 7, 2018

Related U.S. Application Data
(60) Provisional application No. 62/555,810, filed on Sep. 8, 2017.

(51) Int. Cl. G01N 15/08

(52) U.S. Cl. CPC G01N 15/082; G01N 2015/084; G01N 15/0806

(57) ABSTRACT

The present invention includes an apparatus and method for testing sterility filter integrity comprising: a compressor connected to a pressure regulator across a first valve and to a pressure gauge across the pressure regulator; a second valve connected to the pressure regulator opposite the first valve and connected to a fitting capable of connection to a sterility filter, across a second valve; a stopcock connected between the second valve and the sterility filter, wherein the stopcock provides a port for wetting a dried filter; and a flexible hose having a fitting that connects to the sterility filter opposite the pressure regulator in communication with a container with water, wherein a failure of sterility filter integrity is determined by detecting bubbles in the water across a wet filter at a bubble point pressure of the sterility filter.

### CROSS-REFERENCE TO RELATED APPLICATIONS

This application claims priority to U.S. Provisional Application Ser. No. 62/555,810, filed Sep. 8, 2017, the entire contents of which are incorporated herein by reference.

### STATEMENT OF FEDERALLY FUNDED RESEARCH

None.

### TECHNICAL FIELD OF THE INVENTION

The present invention relates in general to the field of filtering intravenous (IV) admixtures prepared from any non-sterile ingredients, and more particularly, to a novel device and method to confirm the integrity of the filter.

### BACKGROUND OF THE INVENTION

Without limiting the scope of the invention, its background is described in connection with filter testing equipment.

One such system is taught in U.S. Pat. No. 8,084,259, issued to DiLeo, and entitled “Method of insuring the integrity of a filtering element”. Briefly, this inventor is said to teach a system for accurately measuring the concentration of a substance within a filter housing using a concentration sensor and a communications device coupled so as to measure and transmit the concentration of a particular substance within the filter housing while in use, such one or more tracer gas (helium or hydrogen), which is added to a carrier and injected into the system. The concentration of tracer gas at a specific operating transmembrane pressure is indicative of bubble pointing specific pores in the filter and is said to provide a more sensitive indication of the bubble point and the presence of defects than a standard diffusion test.

Another such system is taught in U.S. Pat. No. 7,594,425, issued to Lewnard, et al., and entitled, “Methods and systems for integrity testing of porous materials”. Briefly, these inventors are said to teach a method and system for integrity testing of porous material using a plurality of gases.

Another such system is taught in U.S. Pat. No. 6,003,363, issued to Danielson, et al., and entitled “Leak detection apparatus and method”. Briefly, these inventors are said to teach a bubble leak tester, and associated methods that allow for simple, inexpensive, quick and accurate testing of the test part, provides a visual indication of a leak, and eliminates the part damage and clean-up associated with conventional water immersion tests. More particularly, a leak tester is provided that is connectable to a reference volume and a test volume for determining the presence of a leak in the test volume.

Another such system is taught in U.S. Pat. No. 5,576,480, issued to Hopkins, et al., and entitled “System and method for testing the integrity of porous elements”. Briefly, these inventors are said to teach an apparatus for detecting defects in porous elements including systems and methods for quantifying acoustic signal data that uses a transducer that receives acoustic signals generated within a test chamber by a porous element. A signal processing device may be included that analyzes the acoustic signals received, for quantifying the acoustic signals, and for correlating the acoustic signals with physical attributes of the porous element.

Another such system is taught in U.S. Pat. No. 5,477,155, issued to Proulx, et al., and entitled “Current flow integrity test.” Briefly, these inventors are said to teach a new method and apparatus for conducting an integrity test on porous membranes and membrane filters and for conducting a pore-size characterization of membrane by applying membrane integrity tests and pore-size characterizations based on the dependence on the pore size of the pressure required to intrude a non-wetting, electrically conductive liquid into and through the pores. This invention uses electrical-measurement methods for identifying the pressure at which intrusion occurs.

Another such system is taught in U.S. Patent Publication Nos. 2008/0110243 and 2010/0223980, filed by Burke, et al., and entitled “Rapid integrity testing of porous materials”. Briefly, these applicants are said to teach a rapid recirculation based integrity testing of porous material that includes the steps of assessing the integrity of a porous material by wetting the porous material with a liquid; contacting a first surface of the porous material with a mixture comprising a carrier and a detectable substance; applying pressure to the first surface of the porous material such that at least some of the carrier and the detectable substance permeate the porous material; recirculating the carrier and detectable substance found in a permeate of the porous material in a fixed volume on the permeate side while continuing to apply the pressure on the first surface; and assessing the concentration of the detectable substance in the permeate of the porous material over time.

Finally, another such system is taught in Published U.S. Application No. 2007/0241510, filed by DiLeo, and entitled “Filter seating monitor”. This applicant is said to teach a method and apparatus for monitoring the integrity of seals, especially those in filtering elements using an electrically conductive material as the sealing material.

The resistance of this material is monitored, as electrical resistance is a function of the compression or strain on the material. One or more switches are installed in or on the end cap of the filtering element and these switches engage when the filtering element is properly seated, which information is then conveyed via wireless communication.

Thus, a need remains for novel devices and methods for confirming the integrity of a filter system used for filtration of intravenous solutions.

### SUMMARY OF THE INVENTION

In one embodiment, the present invention includes an apparatus to test sterility filter integrity comprising: a compressor connected to a pressure regulator across a first valve and to a pressure gauge across the pressure regulator; a second valve connected to the pressure regulator opposite the first valve and connected to a fitting capable of connection to a sterility filter, across a second valve; a stopcock connected between the second valve and the sterility filter, wherein the stopcock provides a port to wet a dried filter; and a flexible hose having a fitting that connects to the sterility filter opposite the pressure regulator in communication with a container with water, wherein a failure of sterility filter integrity is determined by detecting bubbles in the water across a wet filter at a bubble point pressure of the sterility filter. In one aspect, the compressor is capable generating a pressure at least twice the bubble point pressure of the sterility filter tested. In another aspect, the fitting is a leur lock fitting. In another aspect, the apparatus further comprises a third valve connected to a pressure relief valve, wherein opening the third valve resets a pressure at the pressure gauge to 0 psi. In another aspect, the apparatus further comprises an elbow connector between the second valve and a T-fitting that provides a corrected angle to test the sterility filter. In another aspect, a syringe is connected to a syringe fitting in communication with a T-fitting to provide a fluid that wets the sterility filter. In another aspect, the compressor further comprises a compressor pressure regulator set at no more than twice the bubble point pressure of the sterility filter. In another aspect, the apparatus is adapted to be portable.

In one embodiment, the present invention includes a method of testing the integrity of a sterility filter comprising: providing a compressor connected to a pressure regulator across a first valve and to a pressure gauge across the pressure regulator; connecting a second valve connected to the pressure regulator opposite the first valve and to a fitting capable of connection to a sterility filter, across a second valve; connecting a stopcock between the second valve and the sterility filter, wherein the stopcock provides a port for wetting a dried filter; connecting a flexible hose having a fitting to the sterility filter opposite the pressure regulator in communication with a container with water; and opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter. In one aspect, the compressor generates a pressure at least twice the bubble point pressure of the sterility filter tested. In another aspect, the fitting is a leur lock fitting. In another aspect, the method further comprises connecting a third valve to a pressure relief valve, wherein opening the third valve resets a pressure at the pressure gauge to 0 psi. In another aspect, the method further comprises connecting an elbow between the second valve and a T-fitting that provides a corrected angle for testing the sterility filter. In another aspect, the method further comprises connecting a syringe to a fitting in communication with a T-fitting to provide a fluid that wets the sterility filter. In another aspect, the compressor further comprises a compressor pressure regulator set at no more than twice the bubble point pressure of the sterility filter. In another aspect, the sterility filter passes a sterility filter test when the sterility filter is pressurized at the bubble point pressure and no bubbles are detected in the water. In another aspect, an integrity of the sterility filter is further confirmed by increasing the pressure across the sterility filter until the sterility filter fails are bubbles are detected in the water.

In one embodiment, the present invention includes a method of confirming sterility of a solution for medical use comprising: filtering the solution across a sterility filter; and testing the integrity of the sterility filter by: providing a compressor connected to a pressure regulator across a first valve and to a pressure gauge across the pressure regulator; connecting a second valve connected to the pressure regulator opposite the first valve and to a fitting capable of connection to a sterility filter, across a second valve; connecting a stopcock between the second valve and the sterility filter, wherein the stopcock provides a port for wetting a dried filter; connecting a flexible hose having a fitting to the sterility filter opposite the pressure regulator in communication with a container with water; and opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter or sterility is confirmed if bubbles are not detected in the water. In one aspect, the integrity of the sterility filter is further confirmed by increasing the pressure across the filter until the sterility filter fails are bubbles are detected in the water.

### BRIEF DESCRIPTION OF THE DRAWINGS

For a more complete understanding of the features and advantages of the present invention, reference is now made to the detailed description of the invention along with the accompanying figures and in which:

FIG. 1 shows the setup of the present invention. This testing procedure has been validated using the filter manufacture testing procedure. A syringe, connected to a stopcock 3 way valve is used to insure the filter is wet before testing.

FIG. 2 shows a figure of the setup of the present invention that includes the compressor.

FIG. 3 is a flowchart of a method of the present invention.

FIG. 4 is a flowchart of a method of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

The present invention is a portable bubble point tester, which is easy to build, set up and maintain. The present invention can be used for various types of filters requiring a variety of bubble point pressure settings. Intravenous (IV) admixtures prepared from any non-sterile ingredients, supplies, or equipment must be sterilized prior to administration into a human. Filtration through a 0.2 micron filter is an acceptable method of sterilization. Once the product is filter sterilized, the filter must be integrity tested to ensure the product was filtered with a sterilizing filter. The device of the present invention allows the filter to be integrity tested using the filter manufacturer specifications immediately after preparation in less than 30 seconds. The present invention enables rapid sterilization filter testing enabling the admixture to be qualified as sterile immediately after preparation. Furthermore, the system of the present invention is portable, rapid, and adaptable to a variety of filters.

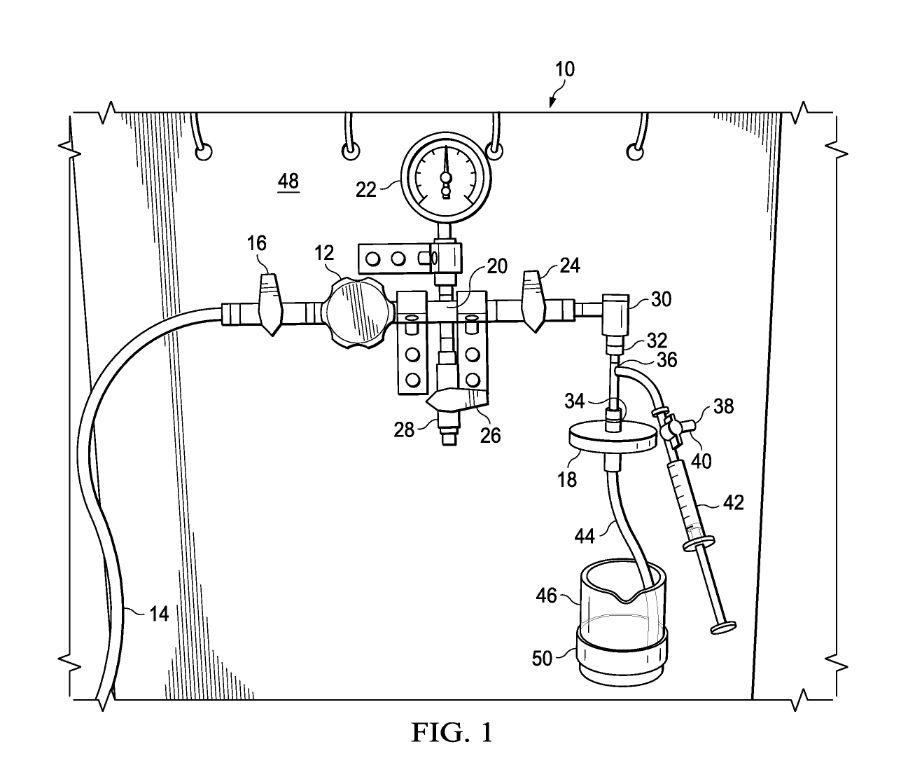

FIG. 1 shows a bubble point filter integrity test unit 10 includes an air compressor with a regulator valve 12 attached by a compression fitting to a flexible line 14, which is selected to withstand the air pressure of operation of the device. This flexible line 14 is connected by a compression fitting to a first valve 16. First valve 16 controls the pressure into the bubble point filter integrity test unit 10. First valve 16 is directly connected to a regulator valve 12. The regulator valve 12 controls the pressure that will be applied to the filter 18 during the integrity test. The regulator valve 12 is directly connected to a four-way connection 20. A pressure gauge 22 is directly connected to the four-way connection 20. The pressure gauge 22 is utilized to monitor the pressure that will be applied to the filter 18 during the integrity test. A third valve 26 is directly connected to the four-way connection 20 and to a bleeder valve 28. The bleeder valve 28 is utilized to bleed the pressure from the system prior to removing the filter 18 after the test. The fourth outlet from the four-way connector is directly connected to second valve 24. Second valve 24 is utilized to apply the pressure registered by the pressure gauge 22 to the filter 18. Once the system is pressurized and the filter 18 to be tested is attached, the second valve 24 is opened slowly (2-4 seconds) to slowly apply pressure to the filter 18 to determine if a steady stream of bubbles appear in the water (filter fails) or bubbles do not appear (filter passes). Second valve 24 is connected to an elbow connection 30 to provide the correct angle for testing the filter 18. The elbow connection 30 is connected to a manifold outlet 32 with a fitting 34, e.g., a leur lock fitting. The fitting 34 is connected to a T-fitting 36 with a fitting, e.g., a leur lock fitting. The side port of the T-fitting 36 is connected to the first inlet of a three-way stopcock 38 with fittings, e.g., leur lock fittings. The second inlet of the three-way stopcock 38 is attached to a leur lock cap 40 to seal off that inlet which is not needed, alternatively, the three-way stopcock 38 can be a straight stopcock. The third port of the three-way stopcock 38 is attached to a syringe 42, which will hold a large enough volume of water to completely wet the filter 18 being tested. The three-way stopcock 38 remains in the closed position unless filter 18 rewetting in needed. If the filter 18 fails the test at first pass, second valve 24 is closed and the three-way stopcock 38 is opened in order for the syringe 42 full of water to be used to rewet the filter 18. Once the filter 18 is rewetted, the three-way stopcock 38 is closed and second valve 24 is opened slowly to reapply pressure to the filter 18. The third port of the T-fitting 36 is fitted with fitting 34 (e.g., a leur lock fitting) utilized to connect the filter 18 being tested. The outflow end of the filter 18 is attached to a flexible tube 44 with, e.g., a fitting that connects to the filter 18, e.g., a leur lock fitting. The free end of the flexible tube 44 is submersed in a beaker 46 of water to observe for bubbles when the pressure is applied to the filter 18.

The four way connection 20, associated valves (16, 24, 26) and gauge connections can be mounted to a solid plate 48, which is then attached to, e.g., an IV pole (not depicted). The beaker 46 is placed in a holder 50 attached to the plate 48. The beaker 46 is removed and filled ¾ full of water to run the test. An air compressor (not depicted) can be mounted on a plate placed on the bottom of the IV pole in order to make the unit one piece, which is portable.

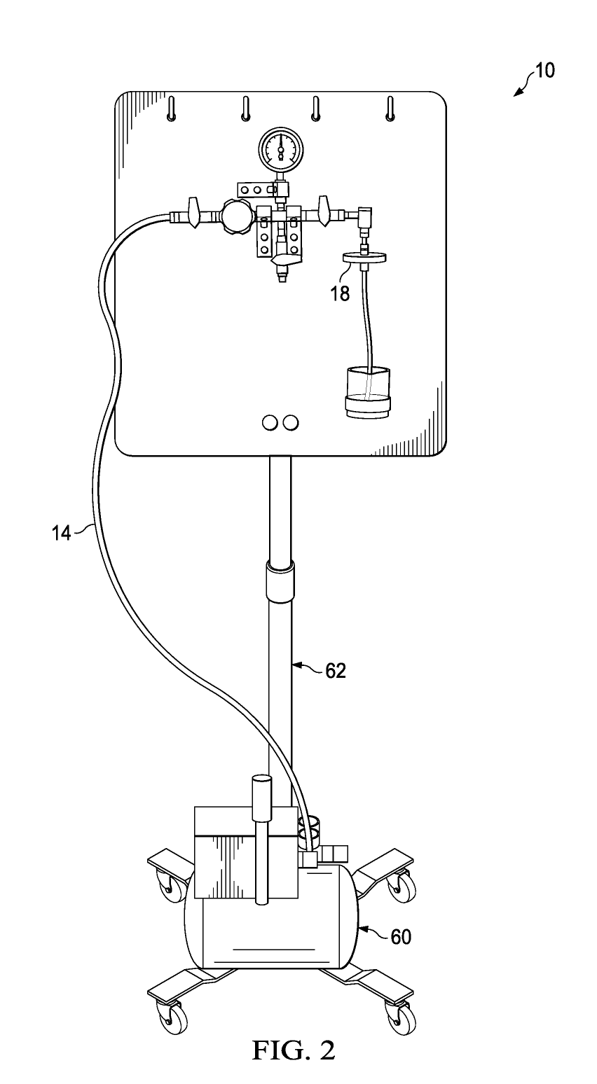

FIG. 2 shows the air compressor 60, the IV pole 62, the flexible line 14, and the bubble point filter integrity test unit 10. The air compressor 60 can be plugged in to pressurize the compressor and then unplugged and moved anywhere the testing would need to occur. The air compressor 60 should be capable of generating a pressure twice the bubble point pressure listed by the manufacturer of the filter being tested. This will enable the system to determine the point at which the filter fails.

In one example, the bubble point filter integrity test unit 10 can be operated as follows:

1. Ensure all compressor 60 valves, bleed valve 28, and first valve 16, second valve 24 and third valve 26 are initially in the closed position, the regulator valve 12 is fully closed, and the pressure gauge 22 reads 0 PSI. If not, open third valve 26 and use the bleeder valve 28 to depressurize the system. Once depressurized, close the bleeder valve 28 and third valve 26.

2. Pressurize the air compressor 60 to a pressure twice the manufacturer recommended bubble point test pressure.

3. Open the regulator valve on the compressor until the pressure matches the manufacturer recommended bubble point pressure for the filter 18.

4. Open first valve 16 and open the regulator valve 12 until the pressure gauge 22 matches the manufacturer recommended bubble point pressure for the filter 18.

5. Once the filter 18 has been used, attach the filter 18 to the leur lock 34 on the free end of the T-fitting 36. Attach the leur lock on the flexible tubing 44 to the outflow leur lock of the filter 18 to be tested. (This process is simply reversed for filters tested in the reverse direction.)

6. Place the free end of the flexible tubing 44 into the beaker 46 of water ensuring the free end is fully submersed in water.

7. Slowly open second valve 24 (2-4 seconds) to apply pressure to the filter 18 being tested.

8. Observe for a steady stream of bubbles once the second valve 24 is fully opened. If a steady stream of bubbles in the water in the beaker 46 does not appear, the filter 18 passes the integrity test.

9. If a steady stream of bubbles appears in the water in the beaker 46, the filter 18 must be rewetted. To rewet the filter 18, close second valve 24, open the stopcock 38, and push the water from the attached syringe 42 into the filter 18. Once the filter 18 has been rewet, close the stopcock 38 and repeat steps 7 and 8. If a steady stream of bubbles does not appear in the water in the beaker 46, the filter 18 passes the integrity test. If a steady stream of bubbles appears in the water in the beaker 46, the filter 18 fails the integrity test. Therefore, sterility of the filtered product cannot be assured and the filtered product cannot be utilized clinically.

The present inventors tested 23 filters using the current device. The third filter tested failed at first, the filter passed after wetting the filter. As such, the design of the present invention was found to be robust, as well as easy and quick to use.

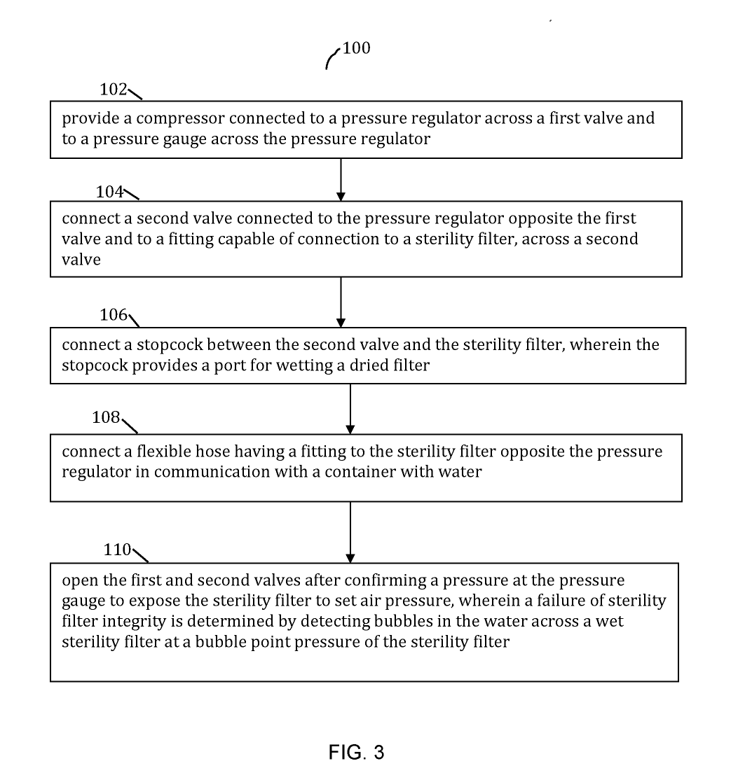

FIG. 3 is a flowchart 100 of a method of the present invention. Flowchart 100 is a method of testing the integrity of a sterility filter comprising, at step 102, providing a compressor connected to a pressure regulator across a first valve and to a pressure gauge across the pressure regulator. At step 104, the method further includes connecting a second valve connected to the pressure regulator opposite the first valve and to a fitting capable of connection to a sterility filter, across a second valve. At step 106, the method further includes connecting a stopcock between the second valve and the sterility filter, wherein the stopcock provides a port for wetting a dried filter. At step 108, the method further includes connecting a flexible hose having a fitting to the sterility filter opposite the pressure regulator in communication with a container with water. Finally, at step 110, opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter.

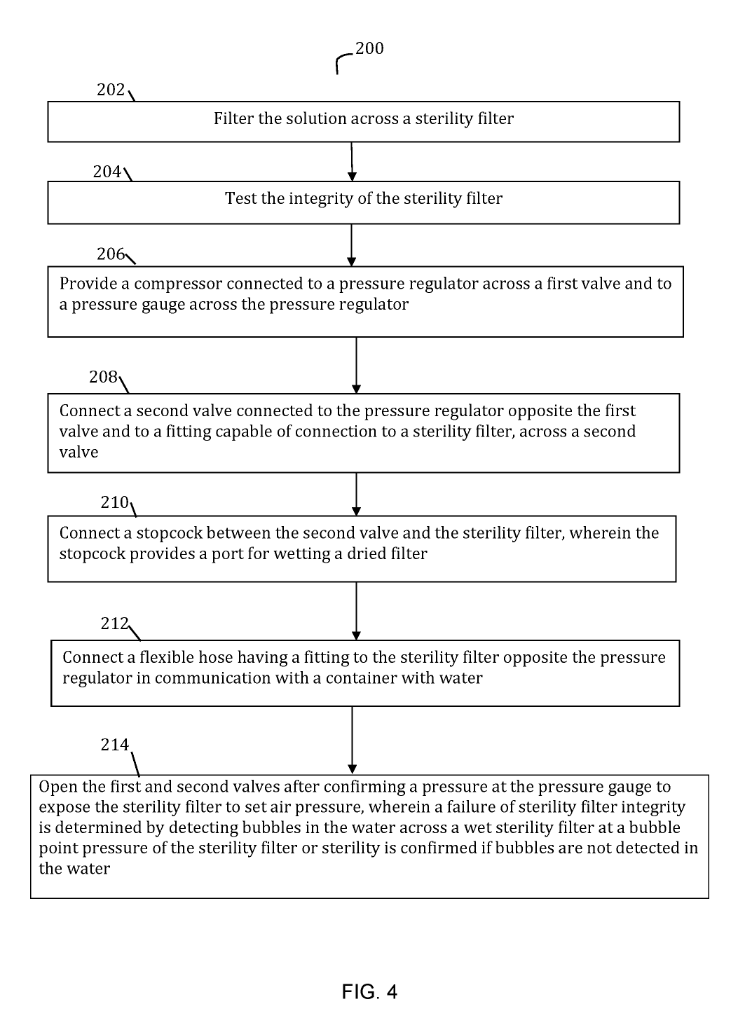

FIG. 4 is a flowchart 200 of a method of the present invention. Flowchart 200 is a method of confirming sterility of a solution for medical use comprising, at step 202, filtering the solution across a sterility filter. Next, at step 204, testing the integrity of the sterility filter by: providing a compressor connected to a pressure regulator across a first valve and to a pressure gauge across the pressure regulator (step 206); connecting a second valve connected to the pressure regulator opposite the first valve and to a fitting capable of connection to a sterility filter, across a second valve (step 208); connecting a stopcock between the second valve and the sterility filter, wherein the stopcock provides a port for wetting a dried filter (step 210); and connecting a flexible hose having a fitting to the sterility filter opposite the pressure regulator in communication with a container with water (step 212). Finally, at step 214, the method further includes opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter or sterility is confirmed if bubbles are not detected in the water.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention.

As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An apparatus to test sterility filter integrity comprising:
a compressor connected to a pressure regulator across a first valve and to a pressure gauge across the pressure regulator;
a second valve connected to the pressure regulator opposite the first valve and connected to a fitting capable of connection to a sterility filter, across a second valve;
a stopcock connected between the second valve and the sterility filter, wherein the stopcock provides a port to wet a dried filter; and
a flexible hose having a fitting that connects to the sterility filter opposite the pressure regulator in communication with a container with water, wherein a failure of sterility filter integrity is determined by detecting bubbles in the water across a wet filter at a bubble point pressure of the sterility filter.

2. The apparatus of claim 1, wherein the compressor is capable generating a pressure at least twice the bubble point pressure of the sterility filter tested.

3. The apparatus of claim 1, wherein the fitting is a leur lock fitting.

4. The apparatus of claim 1, further comprising a third valve connected to a pressure relief valve, wherein opening the third valve resets a pressure at the pressure gauge to 0 psi.

5. The apparatus of claim 1, further comprising an elbow connector between the second valve and a T-fitting that provides a corrected angle to test the sterility filter.

6. The apparatus of claim 1, wherein a syringe is connected to a syringe fitting in communication with a T-fitting to provide a fluid that wets the sterility filter.

7. The apparatus of claim 1, wherein the compressor further comprises a compressor pressure regulator set at no more than twice the bubble point pressure of the sterility filter.

8. The apparatus of claim 1, wherein the apparatus is adapted to be portable.

9. A method of testing the integrity of a sterility filter comprising:
providing a compressor connected to a pressure regulator across a first valve and to a pressure gauge across the pressure regulator;
connecting a second valve connected to the pressure regulator opposite the first valve and to a fitting capable of connection to a sterility filter, across a second valve;
connecting a stopcock between the second valve and the sterility filter, wherein the stopcock provides a port for wetting a dried filter;
connecting a flexible hose having a fitting to the sterility filter opposite the pressure regulator in communication with a container with water; and
opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter.

10. The method of claim 9, wherein the compressor generates a pressure at least twice the bubble point pressure of the sterility filter tested.

11. The method of claim 9, wherein the fitting is a leur lock fitting.

12. The method of claim 9, further comprising connecting a third valve to a pressure relief valve, wherein opening the third valve resets a pressure at the pressure gauge to 0 psi.

13. The method of claim 9, further comprising connecting an elbow between the second valve and a T-fitting that provides a corrected angle for testing the sterility filter.

14. The method of claim 9, further comprising connecting a syringe to a fitting in communication with a T-fitting to provide a fluid that wets the sterility filter.

15. The method of claim 9, wherein the compressor further comprises a compressor pressure regulator set at no more than twice the bubble point pressure of the sterility filter.

16. The method of claim 9, wherein the sterility filter passes a sterility filter test when the sterility filter is pressurized at the bubble point pressure and no bubbles are detected in the water.

17. The method of claim 9, wherein an integrity of the sterility filter is further confirmed by increasing the pressure across the sterility filter until the sterility filter fails are bubbles are detected in the water.

18. A method of confirming sterility of a solution for medical use comprising:
filtering the solution across a sterility filter; and
testing the integrity of the sterility filter by:
providing a compressor connected to a pressure regulator across a first valve and to a pressure gauge across the pressure regulator;
connecting a second valve connected to the pressure regulator opposite the first valve and to a fitting capable of connection to a sterility filter, across a second valve;
connecting a stopcock between the second valve and the sterility filter, wherein the stopcock provides a port for wetting a dried filter;
connecting a flexible hose having a fitting to the sterility filter opposite the pressure regulator in communication with a container with water; and
opening the first and second valves after confirming a pressure at the pressure gauge to expose the sterility filter to set air pressure, wherein a failure of sterility filter integrity is determined by detecting bubbles in the water across a wet sterility filter at a bubble point pressure of the sterility filter or sterility is confirmed if bubbles are not detected in the water.

19. The method of claim 18, wherein the integrity of the sterility filter is further confirmed by increasing the pressure across the filter until the sterility filter fails are bubbles are detected in the water.
